(19) United States
(12) Patent Application Publication
(10) Pub. No.: US 2026/0302506 A1
(43) Pub. Date: Oct. 1, 2026

(54) ANISOTROPIC SHIELD BURST OPTIMIZATION

(71) Applicant: Toyota Motor Engineering & Manufacturing North America, Inc., Plano, TX (US)

(72) Inventors: David R. Eilken, Ann Arbor, MI (US); Oana Nitulescu, Ann Arbor, MI (US)

(73) Assignees: Toyota Motor Engineering & Manufacturing North America, Inc., Plano, TX (US); Toyota Jidosha Kabushiki Kaisha, Aichi-ken (JP)

(21) Appl. No.: 19/095,576

(22) Filed: Mar. 31, 2025

(51) Int. Cl. H01M 50/342; H01M 50/211; H01M 50/271

(52) U.S. Cl. CPC H01M 50/3425; H01M 50/211; H01M 50/271

(57) ABSTRACT

Methods and systems may provide for a performance-enhanced battery pack cover that includes a sheet portion having a substantially planar cross-section and one or more vent releases coupled to the sheet portion, the one or more vent releases having a substantially non-planar cross-section, wherein the one or more vent releases include an anisotropic material, and wherein a relatively weak direction of the anisotropic material is aligned with a lateral direction of the one or more vent releases.

### TECHNICAL FIELD

Embodiments generally relate to battery covers. More particularly, embodiments relate to anisotropic shield burst optimization in battery covers.

### BACKGROUND

Battery packs can be useful in a wide variety of settings such as, for example, hybrid vehicles (HV), plug-in hybrid vehicles (PHEV), and electric vehicles (EVs). Thermal runaway in one or more cells of a battery pack (e.g., as a result of overcharging, rapid charging, relatively high ambient temperatures, etc.) is a hazardous condition in which ignition in the cell(s) leads to gas and particles of the cell(s) being ejected. Propagation of this ignition to nearby cells may lead to further damage and/or injury. Conventional solutions to addressing thermal runaway may include installing a penetrable cover over the battery pack to serve as a pressure release mechanism for the triggering cell, and protection for the neighboring cell(s). Many such covers, however, are too strong (e.g., thermal runaway does not lead to penetration of the cover), too weak (e.g., adjacent cells/modules are damaged and/or the cover breaks during handling), difficult to tune and/or unreliable.

### BRIEF SUMMARY

In one embodiment, a battery pack comprises a battery module and a cover coupled to the battery module, the cover including a sheet portion having a substantially planar cross section and one or more vent releases coupled to the sheet portion, the one or more vent releases having a substantially non-planar cross-section, wherein the one or more vent releases include an anisotropic material, and wherein a relatively weak direction of the anisotropic material is aligned with a lateral direction of the one or more vent releases.

In another embodiment, a performance-enhanced battery pack cover comprises a sheet portion having a substantially planar cross-section and one or more vent releases coupled to the sheet portion, the one or more vent releases having a substantially non-planar cross-section, wherein the one or more vent releases include an anisotropic material, and wherein a relatively weak direction of the anisotropic material is aligned with a lateral direction of the one or more vent releases.

In yet another embodiment, a method of fabricating a battery pack cover comprises providing a sheet portion having a substantially planar cross-section and coupling one or more vent releases to the sheet portion, the one or more vent releases having a substantially non-planar cross-section, wherein the one or more vent releases include an anisotropic material, and wherein a relatively weak direction of the anisotropic material is aligned with a lateral direction of the one or more vent releases.

### BRIEF DESCRIPTION OF THE SEVERAL VIEWS OF THE DRAWINGS

The various advantages of the embodiments of the present invention will become apparent to one skilled in the art by reading the following specification and appended claims, and by referencing the following drawings, in which:

FIG. 1 is an exploded perspective view of an example of a set of battery packs according to an embodiment;

FIG. 2 is an enlarged sectional view taken along lines 2-2 in FIG. 1 of an example of a battery pack according to an embodiment;

FIG. 3 is an enlarged sectional view of a thermal runaway event in a battery pack according to an embodiment;

FIG. 4 is a side view of an example of a thermal runaway event and a particle rebound event in a set of battery packs according to an embodiment;

FIG. 5 is an illustration of an example of a set of thresholds associated with a thermal runaway event, a particle rebound event and a handling event according to an embodiment;

FIG. 6 is a comparative side view of an example of a conventional battery pack cover and an enhanced battery pack cover according to an embodiment;

FIG. 7 is an illustration of an example of a relatively weak direction of an anisotropic material that is aligned with a lateral direction according to an embodiment;

FIG. 8 is an illustration of an example of lateral components of thermal runaway forces relative to one or more vent releases of a battery pack cover according to an embodiment; and

FIGS. 9A and 9B are flowcharts of examples of methods of fabricating a battery cover according to an embodiment.

### DETAILED DESCRIPTION

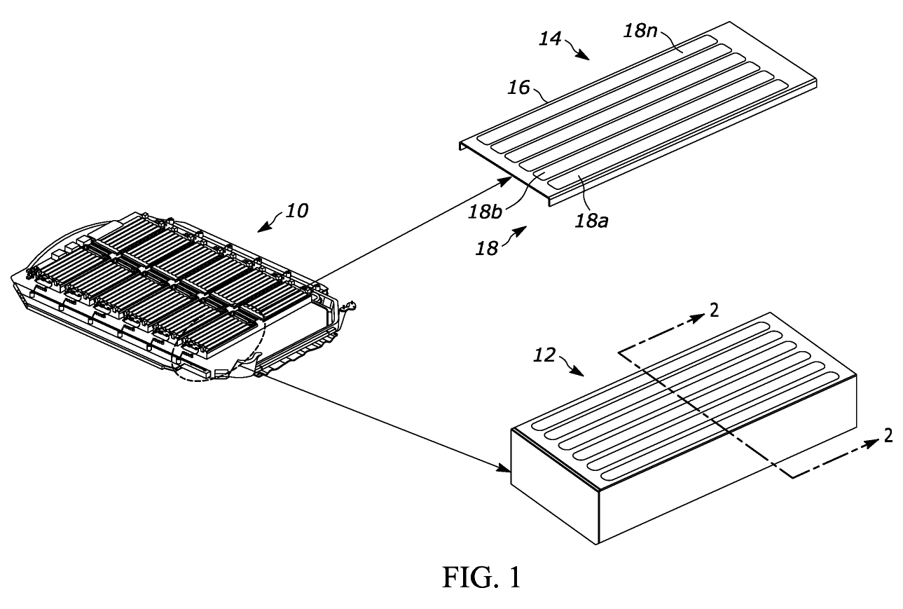

Turning now to FIG. 1, a set of battery packs 10 is shown in which a plurality of covers 14 (e.g., shields) are coupled to a corresponding plurality of battery modules 12. In general, the covers 14 protect against damage from thermal runaway in one or more cells of the battery packs 10 (e.g., as a result of overcharging, rapid charging, relatively high ambient temperatures, etc.). More particularly, each cover 14 includes a sheet portion 16 (e.g., first portion) having a substantially planar cross-section and one or more vent releases 18 (18a-18n, e.g., second portions) coupled to the sheet portion 16.

As will be discussed in greater detail, the vent release(s) 18 have a substantially non-planar cross-section and include an anisotropic material. In an embodiment, the strength of the anisotropic material differs according to the direction of measurement across the material (e.g., some directions are relatively strong, while other directions are relatively weak). A determination can therefore be made as to which direction(s) across the anisotropic material are relatively weak. Additionally, the relatively weak direction of the anisotropic material is aligned with a lateral (e.g., horizontal) direction of the vent release(s) 18. This alignment, combined with the non-planar cross-section of the vent release(s) 18 results in the vent release(s) 18 being more susceptible to puncturing in response to thermal runaway within the battery modules 12, while being relatively resistant to breakage due to particle rebound and/or handling.

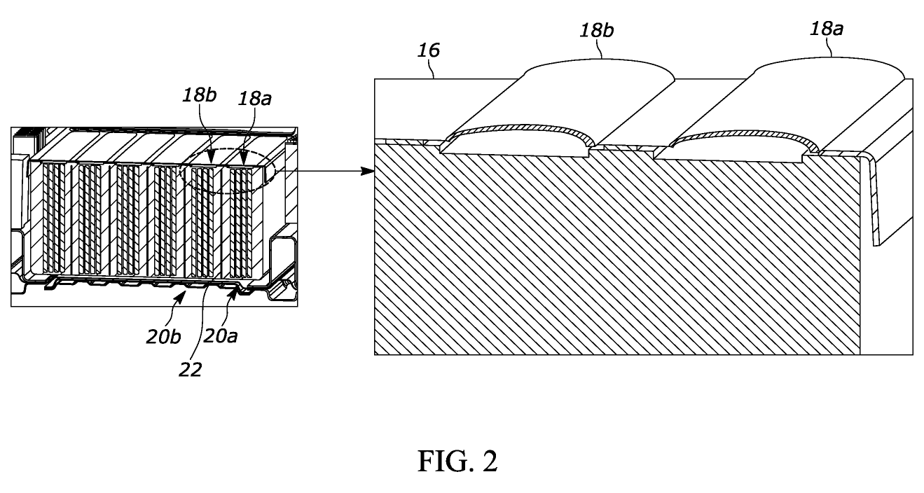

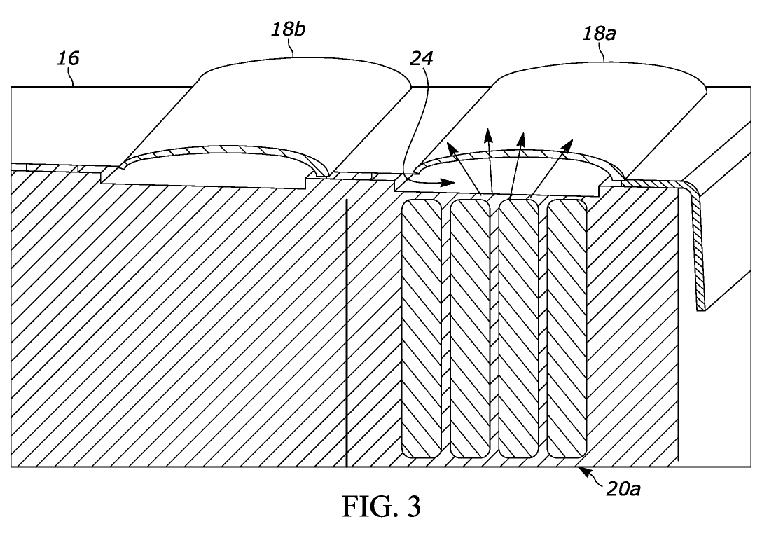

FIGS. 2 and 3 show enlarged views of adjacent vent releases 18a and 18b, wherein a first vent release 18a is positioned above a first group 20a of battery cells and a second vent release 18b is positioned above a second group 20b of battery cells. Although pouch cells are depicted, prismatic, cylindrical, and other cell form factors may also be used. A relatively thin separator 22 is positioned between the first group 20a and the second group 20b. In the illustrated example, the cross-section of the vent releases 18a, 18b includes a single curvature, although other non-planar shapes (e.g., plurality of curvatures) may also be used. As best shown in the example of FIG. 3, the non-planar cross-section adds a horizontal/lateral component to the forces 24 from gases and/or particles associated with thermal runaway events in one or more cells of the first group 20a of battery cells. Because the horizontal/lateral forces are aligned with the weak direction of the anisotropic material, such forces are more likely to cause a rupture in the first vent release 18a. The second vent release 18b provides similar advantages with respect to thermal runaway in one or more cells of the second group 20b of battery cells.

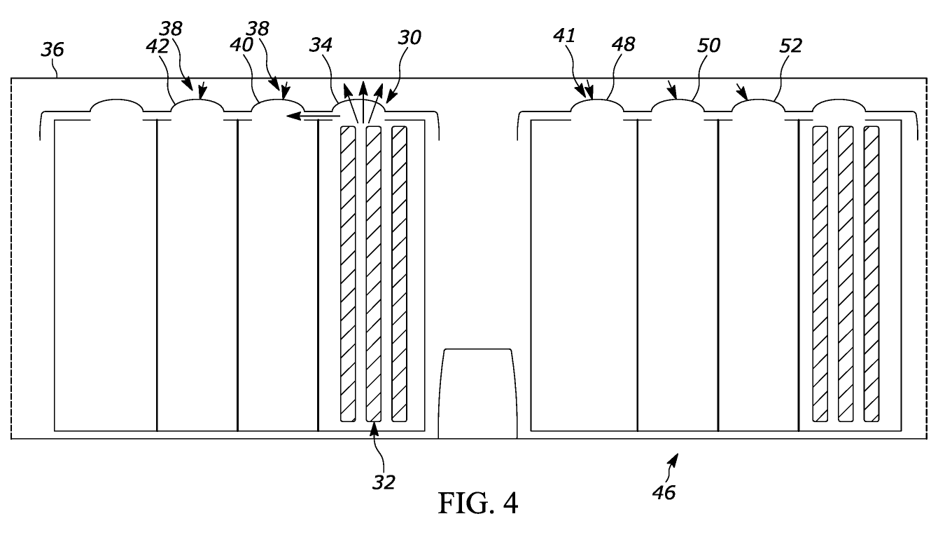

FIG. 4 shows an example of thermal runaway forces 30 from a first group 32 of battery cells puncturing a first vent release 34 and impacting a lid 36 (e.g., top) of the battery pack. In the illustrated example, first particle rebound forces 38 reflect back from the lid 36 towards a second vent release 40 and a third vent release 42 adjacent to the first group 32 of battery cells. Additionally, second particle rebound forces 41 reflect back from the lid 36 towards vent releases 48, 50, 52 of an adjacent battery module 46. As will be discussed in greater detail, the shape and material of the vent releases 40, 42, 48, 50, 52 may prevent the particle rebound forces 38, 41 from puncturing the vent releases 40, 42, 48, 50, 52. In general, the thermal runaway forces 30 may be greater than the particle rebound forces 38, 41.

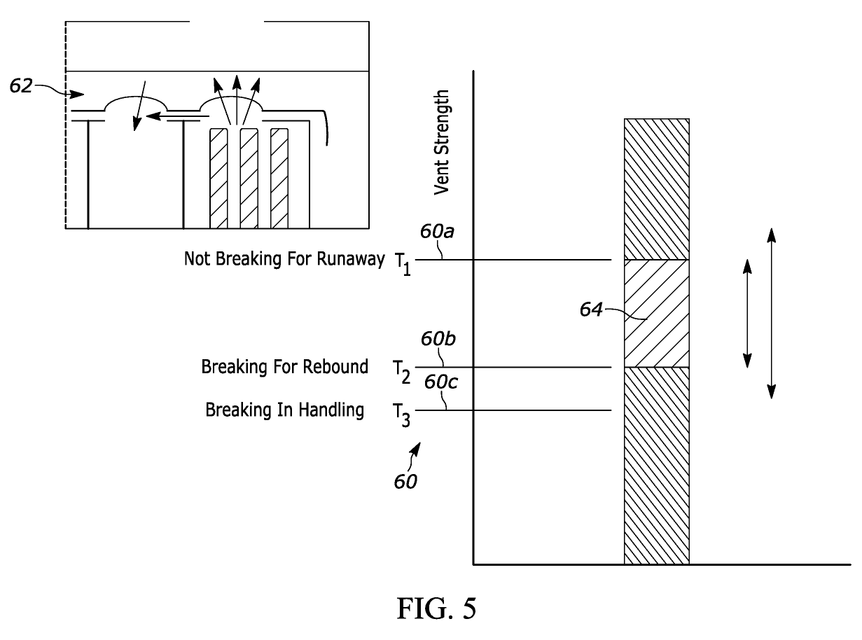

FIG. 5 shows a set of strength thresholds 60 (60a-60c) for one or more vent releases 62. In the illustrated example, a first threshold 60a (T₁) corresponds to a thermal runaway event. Thus, if the vent strength is greater than the first threshold 60a, the thermal runaway event will not puncture the vent release(s) 62. A second threshold 60b (T₂) corresponds to a particle rebound event. Accordingly, if the vent strength is greater than the second threshold 60b, the particle rebound event will not puncture the vent release(s) 62. Additionally, a third threshold 60c (T₃) corresponds to a handling event (e.g., user installation, maintenance, etc.). If the vent strength is greater than the third threshold 60c, a handling event will not puncture the vent release(s) 62. Due to variability in usage scenarios, the third threshold 60c may be difficult to determine to a high degree of certainty.

The vent release(s) 62 described herein have a vent strength falling in an optimized operating region 64. Thus, the strength of the vent release(s) 62 is less than the first threshold 60a, greater than the second threshold 60b and greater than the third threshold 60c. The vent release(s) 62 are therefore more reliable. Moreover, the alignment of the relatively weak direction of the anisotropic material with the lateral (e.g., horizontal) direction of the vent release(s) 62 combined with the non-planar cross-section of the vent release(s) 62 results in the first threshold 60a increasing (e.g., more susceptibility to puncturing in response to thermal runaway), while the third and second thresholds 60b, 60c remain the same (e.g., being relatively resistant to breakage due to particle rebound and/or handling). Accordingly, the vent releasees 62 are easier to tune.

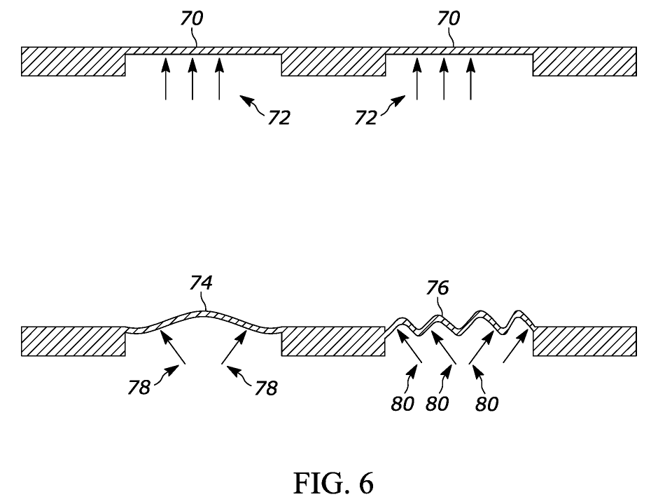

FIG. 6 shows conventional vent releases 70 having a planar cross-section. In the illustrated example, thermal runaway forces 72 are primarily perpendicular (e.g., vertical) to the vent releases 70. By contrast, enhanced vent releases 74, 76 according to the technology described herein have a substantially non-planar cross-section. For example, the cross-section of a first enhanced vent release 74 includes a single curvature. Accordingly, thermal runaway forces 78 have both perpendicular (e.g., vertical) and lateral (e.g., horizontal) components. Similarly, the cross-section of a second enhanced vent release 76 includes a plurality of curvatures and thermal runaway forces 80 have both perpendicular (e.g., vertical) and lateral (e.g., horizontal) components. As already noted, the lateral components of the thermal runaway forces 78, 80 combined with the relatively weak direction of the anisotropic material being aligned with the lateral direction increases the likelihood of the vent releases 74, 76 being ruptured by a thermal runaway event, relative to the conventional vent releases 70.

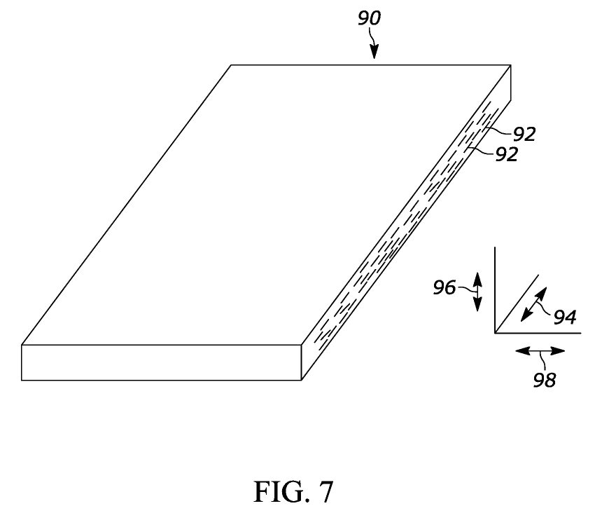

FIG. 7 shows a piece of anisotropic material 90 (e.g., mica, acrylate polymers, cellulose acetate, fiberglass, fishpaper, nylon, phenolics, polycarbonate, polyester, styrene, vinyl-PVC, vulcanized fiber, composites, etc.). In the illustrated example, the orientation of individual fibers 92 (e.g., flakes, composites, crystals) in the anisotropic material 90 determines a relatively weak direction 94 of the anisotropic material 90. More particularly, a tensile strength associated with the relatively weak direction 94 is less than a tensile strength associated with one or more other directions 96, 98 across the anisotropic material. As already mentioned, constructing a vent release from the anisotropic material 90 and aligning the relatively weak direction 94 with the lateral direction of the vent release enables greater performance in terms of handling thermal runaway events.

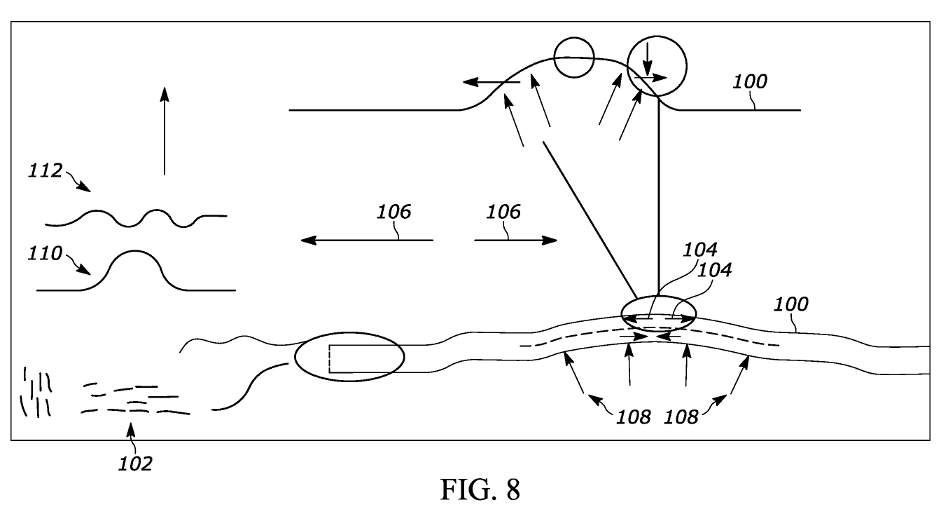

For example, FIG. 8 shows a vent release 100 having a substantially non-planar cross-section and an anisotropic material containing fibers 102 (e.g., flakes, composites, crystals) that are oriented to create a relatively weak direction 104 in the anisotropic material. More particularly, the relatively weak direction 104 is aligned with the lateral direction 106 of the vent release 100 so that the lateral component (e.g., shear) of thermal runaway forces 108 act to “tear” the vent release 100 apart. Although the illustrated non-planar cross-section includes a single curvature 110 (e.g., rib), the non-planar cross-section may also include a plurality of curvatures 112 (e.g., ribs), or other suitable geometry.

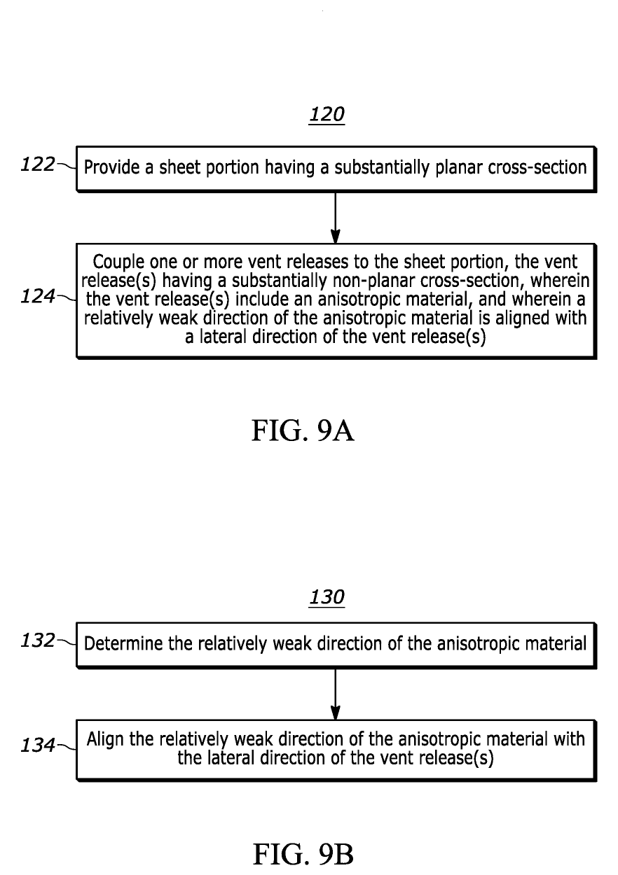

FIG. 9A shows a method 120 of fabricating a battery pack cover (e.g., shield) such as, for example, the battery pack cover 14 (FIG. 1), already discussed. The method 120 may be implemented via manufacturing equipment and/or in logic instructions (e.g., software), configurable logic, fixed-functionality hardware logic, etc., or any combination thereof. Illustrated processing block 122 provides a sheet portion having a substantially planar cross-section. Block 124 couples one or more vent releases to the sheet portion. In the illustrated example, the vent release(s) have a substantially non-planar cross-section, wherein the vent release(s) include an anisotropic material. Additionally, a relatively weak direction of the anisotropic material is aligned with a lateral direction of the vent release(s). As already noted, the strength of the vent release(s) can be less than a first threshold associated with a thermal runaway event, greater than a second threshold associated with a particle rebound event, and greater than a third threshold associated with a handling event.

In an embodiment, block 124 includes forming a single curvature (e.g., rib) and/or a plurality of curvatures (e.g., ribs) in the substantially non-planar cross-section. Moreover, block 124 may incorporate mica into the anisotropic material. The method 120 therefore enhances performance at least to the extent that the non-planar cross-section of the vent release(s) combined with the alignment of the relatively weak direction results in the vent release(s) being more susceptible to puncturing in response to thermal runaway, while being relatively resistant to breakage due to particle rebound and/or handling. The method 120 also renders the vent release(s) easer to tune and more reliable.

FIG. 9B shows another method 130 of fabricating a battery cover (e.g., shield) such as, for example, the battery cover 14 (FIG. 1), already discussed. The method 120 may generally be conducted in conjunction with the method 120 (FIG. 9A), already discussed. More particularly, the method 130 may be implemented via manufacturing equipment and/or in logic instructions (e.g., software), configurable logic, fixed-functionality hardware logic, etc., or any combination thereof. Illustrated processing block 132 provides for determining the relatively weak direction of the anisotropic material (e.g., based on tensile strength). In an embodiment, block 132 includes conducting strength measurements across different directions of the anisotropic material and/or analyzing the orientation of the fibers (e.g., flakes, composites, crystals) of the anisotropic material. These initial evaluations include tensile testing, toughness testing, microscopic cross sectional analysis, etc. Block 134 aligns the relatively weak direction of the anisotropic material with the lateral direction of the vent release(s).

The term “coupled” may be used herein to refer to any type of relationship, direct or indirect, between the components in question, and may apply to electrical, mechanical, fluid, optical, electromagnetic, electromechanical or other connections. In addition, the terms “first”, “second”, etc. may be used herein only to facilitate discussion, and carry no particular temporal or chronological significance unless otherwise indicated.

Those skilled in the art will appreciate from the foregoing description that the broad techniques of the embodiments of the present invention can be implemented in a variety of forms. Therefore, while the embodiments of this invention have been described in connection with particular examples thereof, the true scope of the embodiments of the invention should not be so limited since other modifications will become apparent to the skilled practitioner upon a study of the drawings, specification, and following claims.

We claim:

1. A battery pack comprising:
a battery module; and
a cover coupled to the battery module, the cover including:
a sheet portion having a substantially planar cross-section, and
one or more vent releases coupled to the sheet portion, the one or more vent releases having a substantially non-planar cross-section, wherein the one or more vent releases include an anisotropic material, and wherein a relatively weak direction of the anisotropic material is aligned with a lateral direction of the one or more vent releases.

2. The battery pack of claim 1, wherein a strength of the one or more vent releases is less than a first threshold associated with a thermal runaway event.

3. The battery pack of claim 2, wherein the strength of the one or more vent releases is greater than a second threshold associated with a particle rebound event.

4. The battery pack of claim 2, wherein the strength of the one or more vent releases is greater than a third threshold associated with a handling event.

5. The battery pack of claim 1, wherein the substantially non-planar cross-section includes a single curvature.

6. The battery pack of claim 1, wherein the substantially non-planar cross-section includes a plurality of curvatures.

7. The battery pack of claim 1, wherein the anisotropic material includes mica, and wherein a tensile strength associated with the relatively weak direction is less than a tensile strength associated with one or more other directions across the anisotropic material.

8. A battery pack cover comprising:
a sheet portion having a substantially planar cross-section; and
one or more vent releases coupled to the sheet portion, the one or more vent releases having a substantially non-planar cross-section, wherein the one or more vent releases include an anisotropic material, and wherein a relatively weak direction of the anisotropic material is aligned with a lateral direction of the one or more vent releases.

9. The battery pack cover of claim 8, wherein a strength of the one or more vent releases is less than a first threshold associated with a thermal runaway event.

10. The battery pack cover of claim 9, wherein the strength of the one or more vent releases is greater than a second threshold associated with a particle rebound event.

11. The battery pack cover of claim 9, wherein the strength of the one or more vent releases is greater than a third threshold associated with a handling event.

12. The battery pack cover of claim 8, wherein the substantially non-planar cross-section includes a single curvature.

13. The battery pack cover of claim 8, wherein the substantially non-planar cross-section includes a plurality of curvatures.

14. The battery pack cover of claim 8, wherein the anisotropic material includes mica, and wherein a tensile strength associated with the relatively weak direction is less than a tensile strength associated with one or more other directions across the anisotropic material.

15. A method of fabricating a battery pack cover, the method comprising:
providing a sheet portion having a substantially planar cross-section; and
coupling one or more vent releases to the sheet portion, the one or more vent releases having a substantially non-planar cross-section, wherein the one or more vent releases include an anisotropic material, and wherein a relatively weak direction of the anisotropic material is aligned with a lateral direction of the one or more vent releases.

16. The method of claim 15, further including:
determining the relatively weak direction of the anisotropic material based on a tensile strength; and
aligning the relatively weak direction of the anisotropic material with the lateral direction of the one or more vent releases.

17. The method of claim 15, wherein a strength of the one or more vent releases is less than a first threshold associated with a thermal runaway event, the strength of the one or more vent releases is greater than a second threshold associated with a particle rebound event, and the strength of the one or more vent releases is greater than a third threshold associated with a handling event.

18. The method of claim 15, further including forming a single curvature in the substantially non-planar cross-section.

19. The method of claim 15, further including forming a plurality of curvatures in the substantially non-planar cross-section.

20. The method of claim 15, further including incorporating mica into the anisotropic material.
